(19) United States
(12) Patent Application Publication
(10) Pub. No.: US 2019/0378251 A1
(43) Pub. Date: Dec. 12, 2019

(54) IMAGE PROCESSING METHOD

(71) Applicant: ZENG HSING INDUSTRIAL CO., LTD., Taichung City (TW)

(72) Inventor: Kun-Lung HSU, Taichung City (TW)

(73) Assignee: ZENG HSING INDUSTRIAL CO., LTD., Taichung City (TW)

(21) Appl. No.: 16/002,319

(22) Filed: Jun. 7, 2018

(51) Int. Cl. G06T 5/00; G06T 5/50; G06T 11/20; G06T 3/40

(52) U.S. Cl. CPC G06T 5/006; G06T 3/4007; G06T 11/203; G06T 5/50

(57) ABSTRACT

An image processing method includes: acquiring an image of a calibration board; acquiring a plurality of feature points in the image of the calibration board; evaluating a plurality of control parameters based on the feature points, the control parameters cooperatively defining a geometric curved surface that fits the feature points; and performing image correction on a to-be-corrected image based on the geometric curved surface to generate a corrected image.

### FIELD

The disclosure relates to an image processing method, and more particularly to an image processing method utilizing a non-uniform rational B-splines model.

### BACKGROUND

In a conventional method for correcting image distortion resulting from camera lenses, a distortion model is constructed based on geometric designs of the camera lenses, and images are corrected according to the distortion model. For instance, the distortion model for a fisheye lens is a polynomial model.

In addition to the geometric designs of the camera lenses, lens deformation during manufacturing, imprecision of lens assembly, and/or imprecision of placement of the image sensor may also result in image distortion.

In a condition where a soft object (e.g., a fabric piece) is placed on an uneven surface (e.g., a curved surface), the image of the soft object thus captured may resemble an image having image distortion. However, the distortion models utilized in the conventional image processing methods are unable to alter the image of the “distorted” soft object (as opposed to one placed on a flat surface) into one resembling an image of the same soft object but placed on a flat surface.

### SUMMARY

Therefore, an object of the disclosure is to provide an image processing method that may be capable of correcting distortion resulting from geometric designs of the camera lenses, lens deformation during manufacturing, imprecision of lens assembly, imprecision of placement of the image sensor, and/or deformation of the captured object itself in the physical world.

According to the disclosure, the image processing method includes: acquiring an image of a calibration board; acquiring a plurality of feature points in the image of the calibration board; evaluating a plurality of control parameters based on the feature points, the control parameters cooperatively defining a geometric curved surface that fits the feature points; and performing image correction on a to-be-corrected image based on the geometric curved surface to generate a corrected image.

### BRIEF DESCRIPTION OF THE DRAWINGS

Other features and advantages of the disclosure will become apparent in the following detailed description of the embodiment (s) with reference to the accompanying drawings, of which:

FIG. 1 is a flow chart illustrating steps of an embodiment of the image processing method according to this disclosure;

FIG. 2 is a schematic diagram illustrating a calibration board;

FIG. 3 is a schematic diagram illustrating a plurality of corner points of an image of the calibration board captured using a fisheye lens;

FIG. 4 is a schematic diagram illustrating a parametric non-uniform rational B-splines surface with a plurality of control points thereof, which is evaluated from the corner points;

FIG. 5 is a schematic diagram illustrating defining a number of pixels of a corrected image;

FIG. 6 is a schematic diagram illustrating a domain of the parametric non-uniform rational B-splines surface;

FIG. 7 is a schematic diagram cooperating with FIGS. 5 and 6 to illustrate acquiring pixel values of the pixels of the corrected image;

FIG. 8 is a schematic diagram illustrating a coordinate plane that is required to be covered by an image coordinate system corresponding to a to-be-corrected image;

FIG. 9 is a schematic diagram illustrating another implementation for calculating the pixel values of the pixels of the corrected image;

FIG. 10 is a schematic diagram exemplarily illustrating a corrected image of a to-be-corrected image which is an image of the calibration board;

FIG. 11 is a schematic diagram illustrating another calibration board;

FIGS. 12A-12E illustrate a first exemplary implementation of this embodiment; and

FIGS. 13A-13F illustrate a second exemplary implementation of this embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

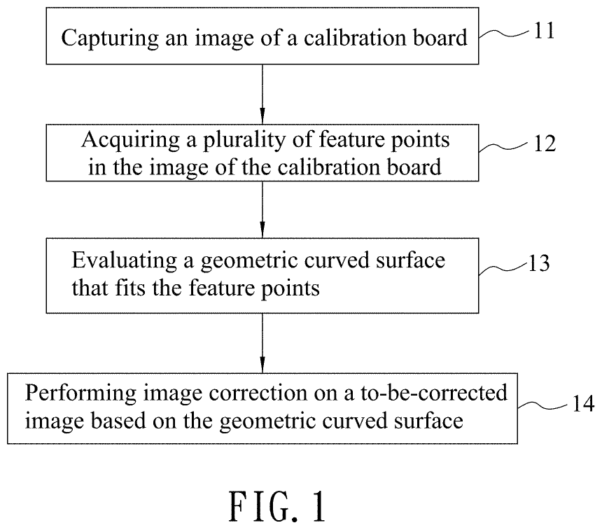

Referring to FIGS. 1 to 3, the embodiment of the image processing method is implemented by a correction system that includes a camera device and a computer device, and includes steps 11-14. The computer device may be a desktop computer, a laptop computer, a tablet computer, etc., and this disclosure is not limited in this respect.

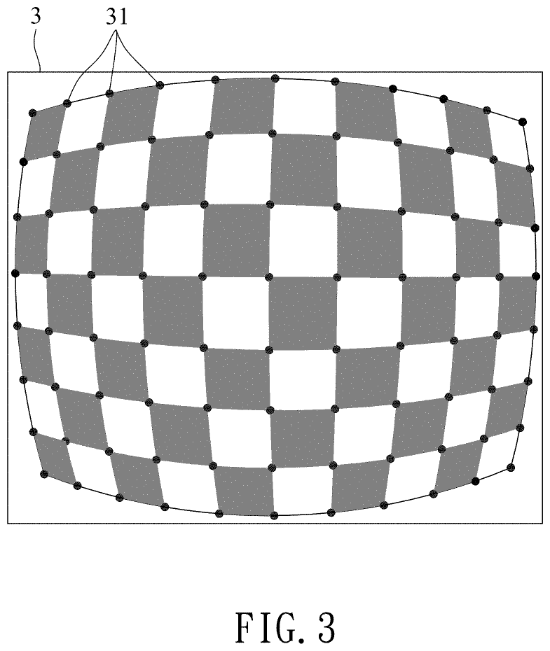

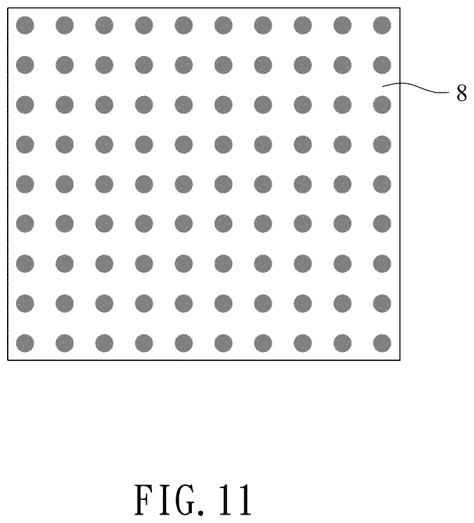

In step 11, the camera device is used to capture an image of a calibration board 2. In this embodiment, the calibration board 2 is a checkerboard, but this disclosure is not limited in this respect. In step 12, the computer device acquires a plurality of feature points in the image of the calibration board 2. In one example, as shown in FIG. 3, the computer device uses the Harris corner detection technique to acquire/recognize a plurality of corner points 31 in the image 3 of the calibration board 2 to serve as the feature points in the form of floating points. In one embodiment, the calibration board 2 may be of other types such as being patterned with regularly spaced dots, as shown in FIG. 11, and the computer device may acquire a center of each dot to serve as the feature points by image recognition techniques.

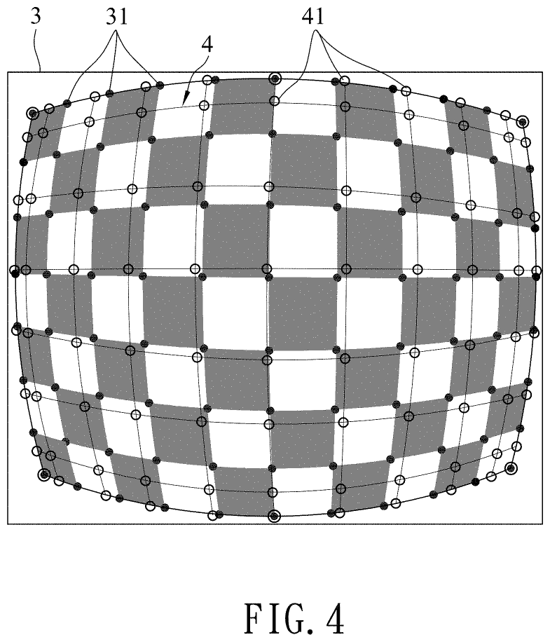

In step 13, referring to FIG. 4, the computer device calculates/evaluates a plurality of control parameters (i.e., control points 41) that cooperatively define a geometric curved surface which fits the feature points 31. In this embodiment, the geometric curved surface is a parametric non-uniform rational B-splines (NURBS) surface 4, which is obtained by parametric NURBS surface interpolation where the feature points 31 are used as interpolation points for evaluating the parametric NURBS surface 4 that fits the feature points 31 and that is defined by:

$$S ( u , v ) = \frac{{\sum }_{i = 0}^{m} {\sum }_{j = 0}^{n} {w}_{i , j} {P}_{i , j} {N}_{i , p} ( u ) {N}_{j , q} ( v )}{{\sum }_{i = 0}^{m} {\sum }_{j = 0}^{n} {w}_{i , j} {N}_{i , p} ( u ) {N}_{j , q} ( v )} ,$$

where S (u,v) represents the parametric NURBS surface 4 defined by (m+1)×(n+1) control parameters (control points 41), m and n are user-defined positive integers, {w_{i,j}} represents a set of weighted values, {P_{i,j}} represents a set of the control points 41 that are calculated using the feature points 31, N_{i,p}(u) represents a normalized B-spline basis function defined on non-periodic knot vectors U={0,0, . . . , 0, uₚ₊₁, . . . , uₘ, 1, 1, . . . , 1}, N_{j,q}(v) represents a normalized B-spline basis function defined on non-periodic knot vectors V={0,0, . . . 0, v_{q+1}, . . . , vₙ,1,1, . . . , 1}, p represents a degree in a direction of the knot vectors U (i.e., an axial direction of a u-axis of a domain 6 of the parametric NURBS surface 4), and q represents a degree in a direction of the knot vectors V (i.e., an axial direction of a v-axis of the domain 6 of the parametric NURBS surface 4). Note that u belongs to [0, 1] and v belongs to [0, 1].

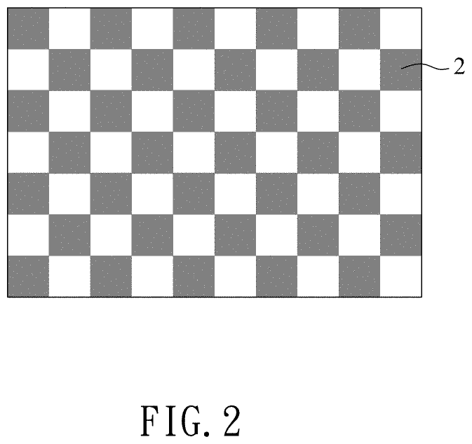

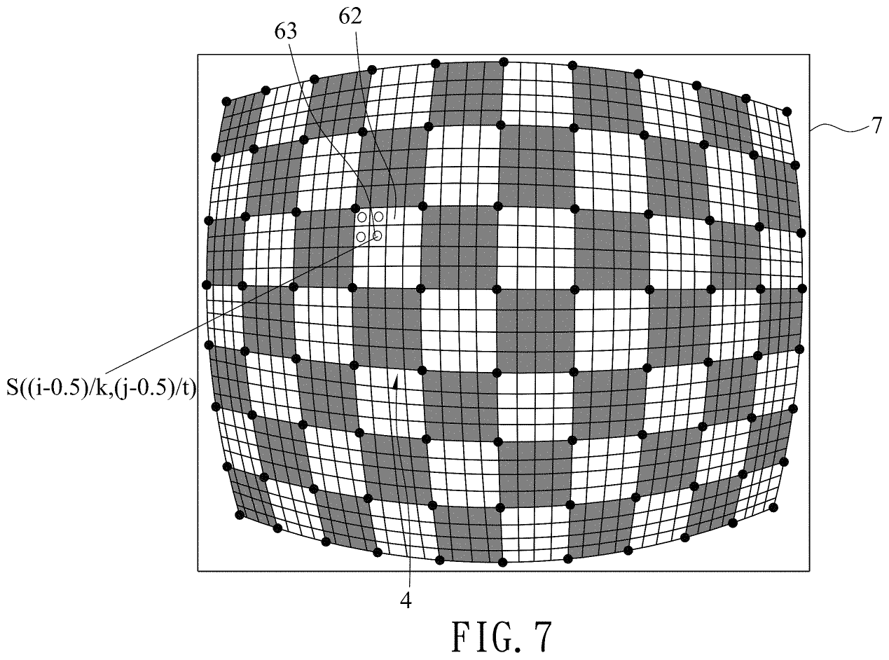

In step 14, the computer device uses the parametric NURBS surface 4 to perform image correction on a to-be-corrected image so as to generate a corrected image. The image 3 of the calibration board 2 in the form of the checkerboard (see FIG. 2) shown in FIG. 3 is used as the to-be-corrected image 7 (see FIG. 7) for illustration hereinafter. As used throughout this disclosure, the expression “correcting an image” or the like is meant to encompass that “image distortion” resulting from optical imperfections are alleviated or eliminated, and/or that whatever object captured in the image that is “distorted” or “made out of shape” in the physical world when the image is taken, like an image of a soft fabric placed on a curve surface, is “flattened” and put back into its “regular shape” after the image correction is completed, as if the image was taken when, for instance, the fabric was placed on a leveled surface.

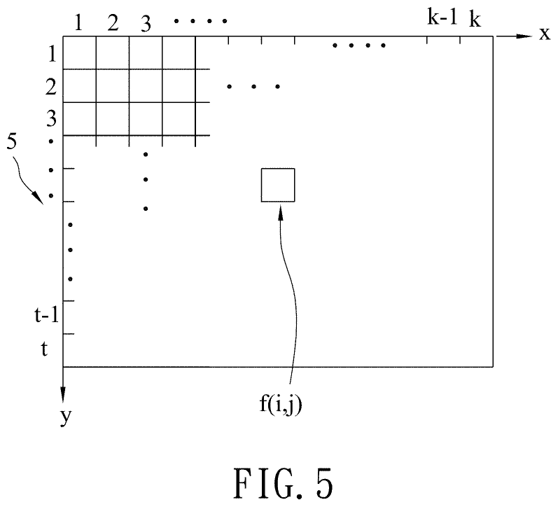

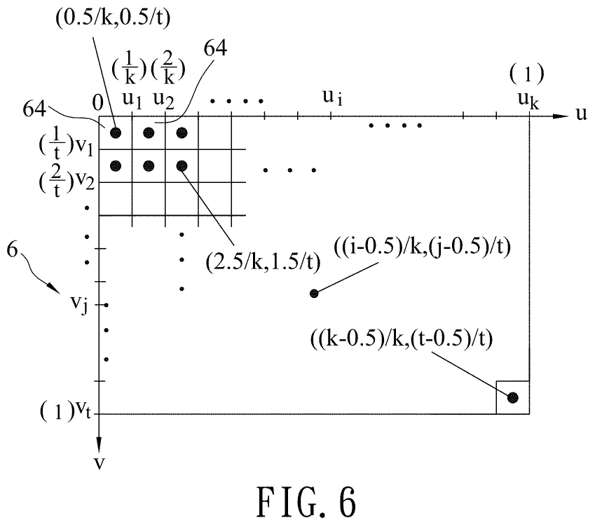

Referring to FIG. 5, for the corrected image 5, a first pixel number (k) along a first image axis (e.g., an x-axis) of the corrected image 5, and a second pixel number (t) along a second image axis that is transverse to the first image axis (e.g., a y-axis) of the corrected image 5 are defined first. In other words, a size/resolution of the corrected image 5 can be set/defined as desired in this correction algorithm. Further referring to FIGS. 6 and 7, the first pixel number (k) of first sample points {uᵢ|i=1, 2, . . . , k}, and the second pixel number (t) of second sample points {vⱼ|j=1, 2, . . . , t} are defined respectively on the u-axis and the v-axis in the domain 6 of the parametric NURBS surface 4. The first and second sample points cooperatively define, on the parametric NURBS surface 4, a plurality of curved surface points (the black dots in FIG. 6) each corresponding to a respective one of pixels of the corrected image 5. In this embodiment, the first sample points equally divide the range between 0 and 1 on the u-axis, i.e., a distance between any two adjacent first sampling points is 1/k; the second sample points equally divide the range between 0 and 1 on the v-axis, i.e., a di stance between any two adjacent second sampling points is 1/t; and coordinates (uᵢ, vⱼ) in the domain 6 correspond to a curved surface point S ((i−0.5)/k, (j−0.5)/t) on the parametric NURBS surface 4. In other words, if f(i,j) is used to represent an (i,j)^{th} pixel of the corrected image 5 (a pixel at the i^{th} column and the j^{th} row of a pixel array of the corrected image 5), f(i,j) corresponds to (uᵢ,vⱼ) and the curved surface point S ((i−0.5)/k, (j−0.5)/t), where i is a positive integer between 1 and k (including 1 and k), and j is a positive integer between 1 and t (including 1 and t). As shown in FIG. 6, the domain 6 is divided into a plurality of identical rectangular or square boxes 64 of which a number is the same as a total number of pixels of the corrected image 5. Each box 64 corresponds to a respective one of the pixels of the corrected image 5, and has a central point that corresponds to a respective one of the curved surface points on the parametric NURBS surface 4. Accordingly, each pixel of the corrected image 5 corresponds to a respective one of the curved surface points that corresponds to the central point of the corresponding box 64. Each box 64 in the domain 6 corresponds to a polygon region 62 of the parametric NURBS surface 4, and each polygon region 62 contains a curved surface point 63 that corresponds to a pixel of the corrected image 5. It should be noted herein that since the parametric NURBS surface 4 is not a flat surface, the polygon regions 62 thereof may differ from each other in size and/or shape. For instance, in the example depicted in FIG. 7, the polygon regions 62 towards the very left may resemble parallelograms with non-right-angle corners, while those in the center may resemble squares.

Then, a pixel value of the pixel f(i,j) of the corrected image 5 may be calculated by performing interpolation (e.g., nearest neighbor interpolation, bilinear interpolation, etc.) based on at least a pixel of the to-be-corrected image 7 that is adjacent to a position corresponding to one of the curved surface points 63 which corresponds to the pixel f(i,j) (the position on the to-be-corrected image 7 that aligns with the corresponding curved surface point 63 when the parametric NURBS surface 4 coincides with the calibration board 2 in the to-be-corrected image 7). For instance, in FIG. 7, the parametric NURBS surface coincides with the calibration board 2 in the to-be-corrected image 7, and the pixel value of a pixel f(5,6) of the corrected image 5 can be calculated based on at least one pixel of the to-be-corrected image 7 that is adjacent to a curved surface point 63 S(4.5/k, 5.5/t) in correspondence to the coordinates (u5, v6) in the domain 6 of the parametric NURBS surface 4.

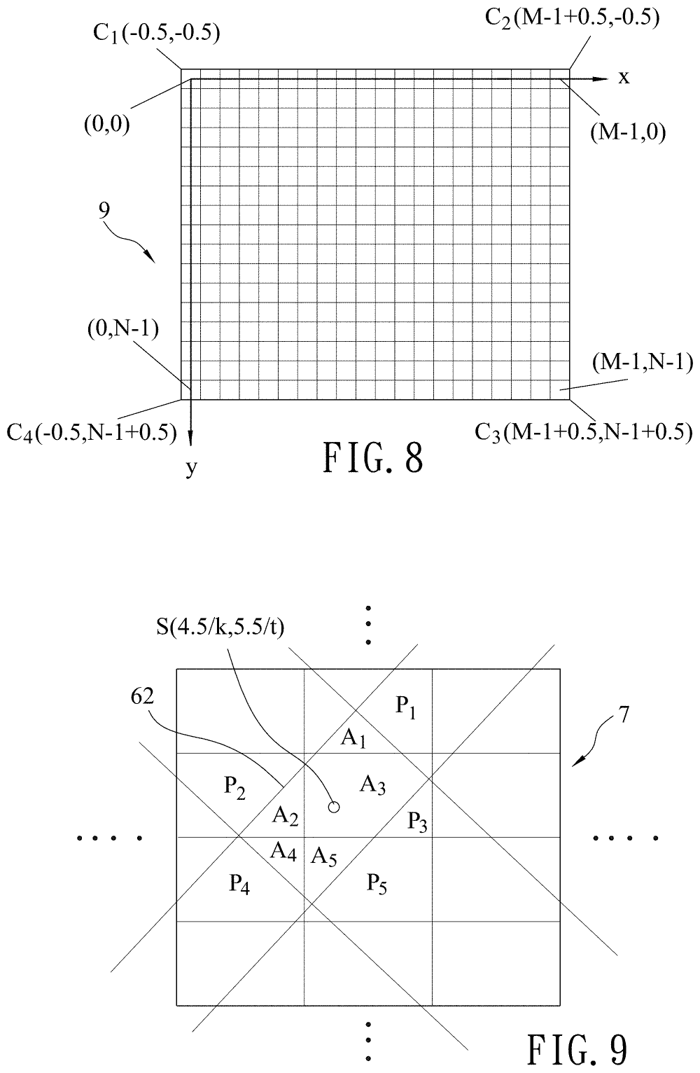

Referring to FIG. 8, since each curved surface point is represented as a floating point, an image coordinate system that corresponds to the to-be-corrected image 7 should cover a coordinate plane 9 defined by four terminal points: C₁(−0.5, −0.5), C₂(M−1+0.5, −0.5), C₃(M−1+0.5,N−1+0.5) and C₄(−0.5,N−1+0.5) when the to-be-corrected image 7 has a number (MxN) of pixels, so as to cover the curved surface points disposed at borders of the parametric NURBS surface 4. The (i,j)^{th} pixel of the to-be-corrected image 7 has a central point of which the coordinates are (i−1,j−1) in the image coordinate system, where i is a positive integer between 1 and M (including 1 and M), and j is a positive integer between 1 and N (including 1 and N).

Referring to FIG. 9, in another implementation, the pixel value of the pixel f(i,j) (e.g., f(5,6)) of the corrected image 5 may be calculated by performing interpolation based on a weighted mean of the pixels of the to-be-corrected image 7 overlapping the polygon region 62 of the parametric NURBS surface 4 which contains the point ((i−0.5)/k, (j−0.5)/t) (e.g., the point S(4.5/k, 5.5/t) in FIG. 9). Each pixel of the to-be-corrected image 7 has a weight being a ratio of an area of the pixel that overlaps the polygon region 62. For instance, in FIG. 9, the polygon area 62 overlaps the pixels P₁ to P₅ of the to-be-corrected image 7 by areas of A₁, A₂, A₃, A₄ and A₅, respectively. Making

$$V = {\sum }_{i = 1}^{5} {A}_{i} ,$$

the weighted mean can be represented by

$${\sum }_{i = 1}^{5} ( \frac{{A}_{i}}{V} \times {p}_{i} ) ,$$

where pᵢ represents a pixel value of the pixel Pᵢ of the to-be-corrected image 7, and Aᵢ/V is the weight for the pixel Pᵢ. In yet another implementation, the weight for the pixel Pi of the to-be-corrected image 7 may be defined based on a distance between a center of the pixel Pᵢ and the point ((i−0.5)/k, (j−0.5)/t) in the to-be-corrected image 7, where the shorter the distance, the greater the weight.

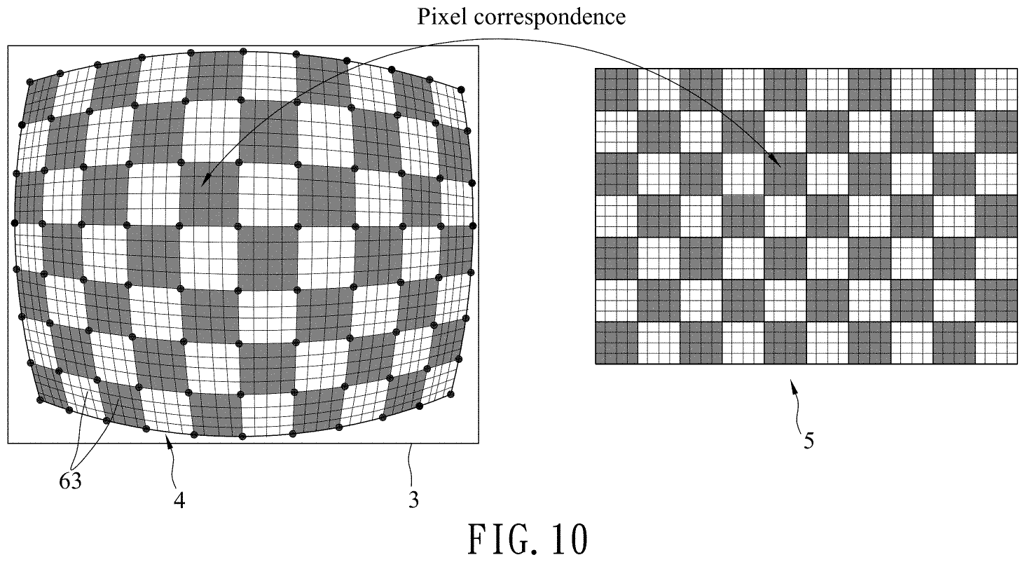

By virtue of the curved surface points 63, any image that is captured using the same camera device can be corrected (in the sense that an object in the captured image may, after the correction is performed, appear un-distorted). FIG. 10 illustrated a corrected image 5 that is acquired by performing the abovementioned image correction on the image 3 of the calibration board 2 (see FIG. 2) which serves as the to-be-corrected image 7.

Since the aforementioned image correction algorithm is based on a capturing result of a camera, distortions resulting from, for instance, geometric design of the camera lens, lens deformation during manufacturing, imprecision of lens assembly, and/or imprecision of placement of the image sensor, can all be alleviated or corrected by the image correction algorithm. In addition, deformation of the captured image which results from the captured object itself in the physical world (for example, a to-be-captured soft fabric piece is placed on a curved surface) can also be un-deformed by use of such image correction algorithm.

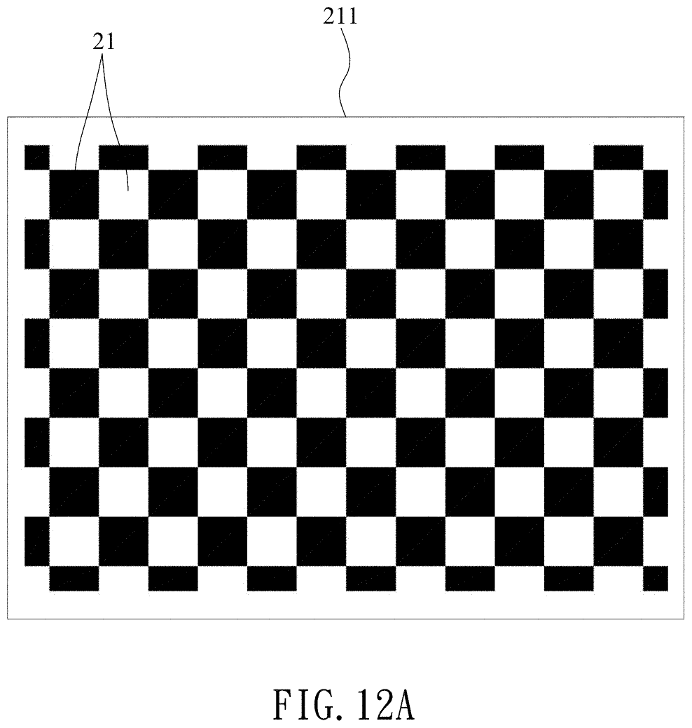

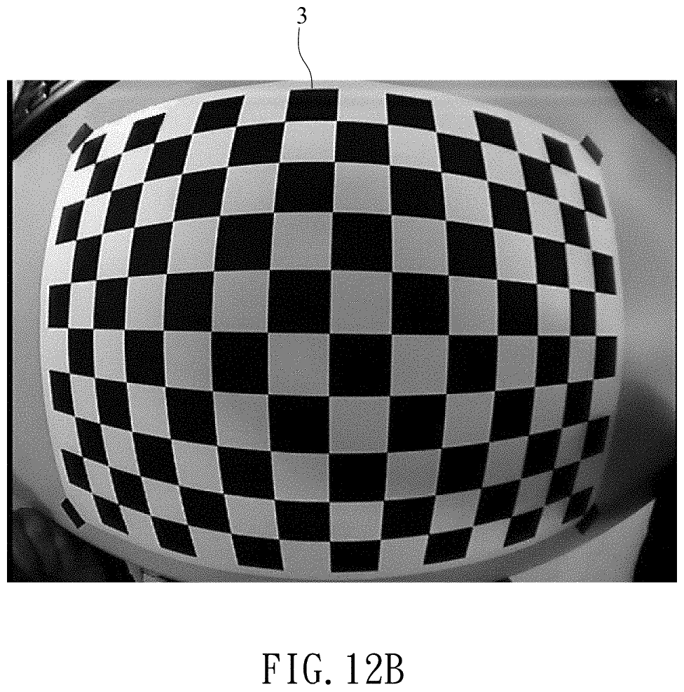

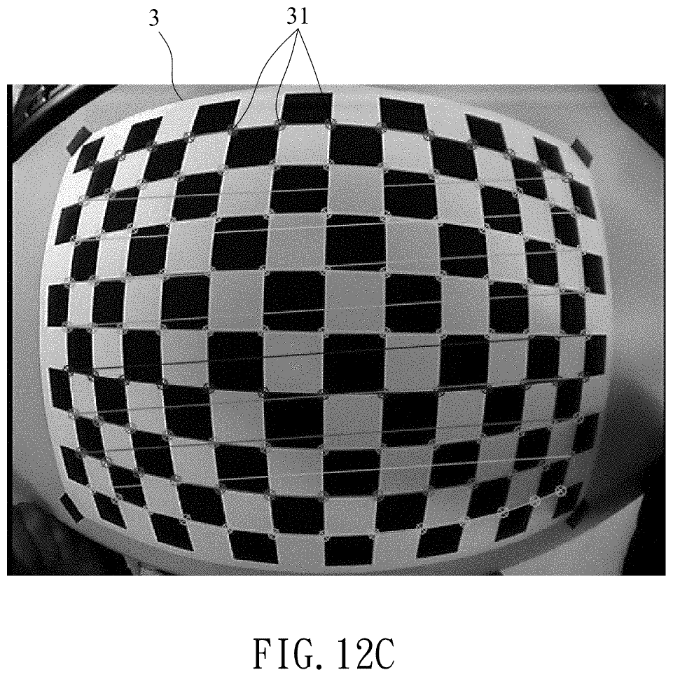

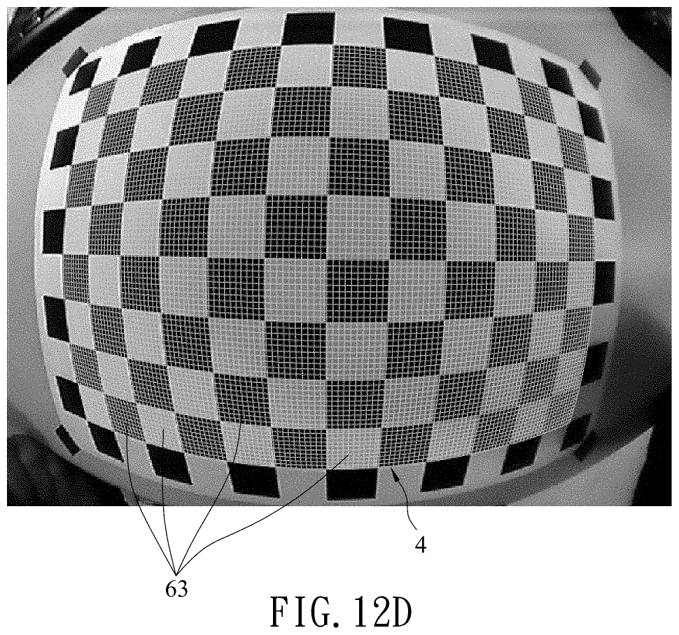

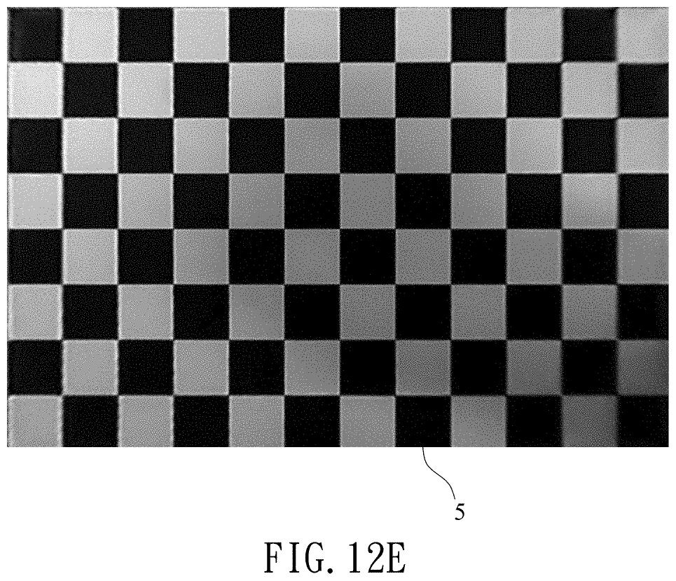

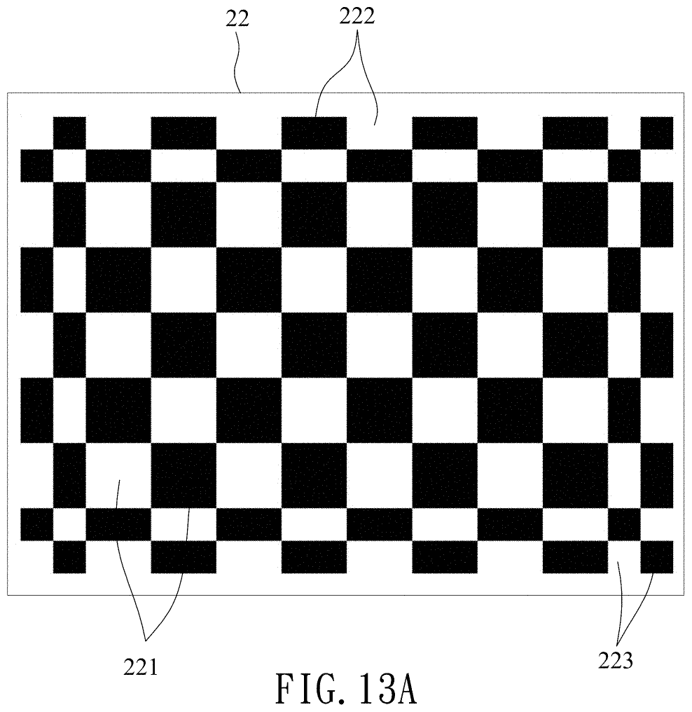

FIGS. 12A-12E illustrate a first exemplary implementation of the embodiment. As shown in FIG. 12A, a checkerboard 21, of which each checker 211 is a square pattern with a side length of 20 mm, is attached to a plane. A camera with a fisheye lens is used to capture an image 3 of the checkerboard 21 (step 11), which has a pixel number of 640×480, as shown in FIG. 12B.

In accordance with step 12, the computer device acquires a number (13×9) of corner points 31 by corner detection, as shown in FIG. 12C, where each of the corner points 31 is represented as a floating point.

In accordance with step 13, the computer device uses the corner points 31 as interpolation points to calculate a parametric NURBS surface 4 that fits the corner points 31, and calculates a plurality of curved surface points 63 that respectively correspond to the central points of the boxes 64 (see FIG. 6 and FIG. 12D). In this exemplary implementation, both of the degree (p) in the u-axis direction and the degree (q) in the v-axis direction are two, the knot vectors that define the u-axis direction for N_{i,p}(u) are [0, 0, 0, 1/11, 2/11, 3/11, 4/11, 5/11, 6/11, 7/11, 8/11, 9/11, 10/11, 1, 1, 1], the interpolated values in the u-axis direction are [0, 1/12, 2/12, 3/12, 4/12, 5/12, 6/12, 7/12, 8/12, 9/12, 10/12, 11/12, 1], the knot vectors that define the v-axis direction for N_{j,q}(v) are [0, 0, 0, 1/7, 2/7, 3/7, 4/7, 5/7, 6/7, 1, 1, 1], the interpolated values in the v-axis direction are [0, 1/8, 2/8, 3/8, 4/8, 5/8, 6/8, 7/8, 1], and each of the weighted values {w_{i,j}} is set to be 1.

In accordance with step 14, the computer device performs, for each curved surface point 63 (represented by each small grid in FIG. 12D), interpolation based on at least one pixel of a to-be-corrected image (the image 3 of the checkerboard 22 is used herein as an example of the to-be-corrected image, but a different image (e.g., of a different object) captured by the same camera with the same fisheye lens at the same angle may be used as the to-be-corrected image) that is adjacent to a position of the curved surface point 63 to acquire a pixel value of a corresponding pixel of a corresponding corrected image.

Note that the curved surface points 63 may be used to perform correction on any image of an object placed on a flat surface which is captured using the fisheye lens, such as the image 3 shown in FIG. 12B. FIG. 12E shows a corrected image 5 obtained by performing the abovementioned image correction on the image 3 shown in FIG. 12B, where the corrected image 5 includes a number 720×480 of pixels.

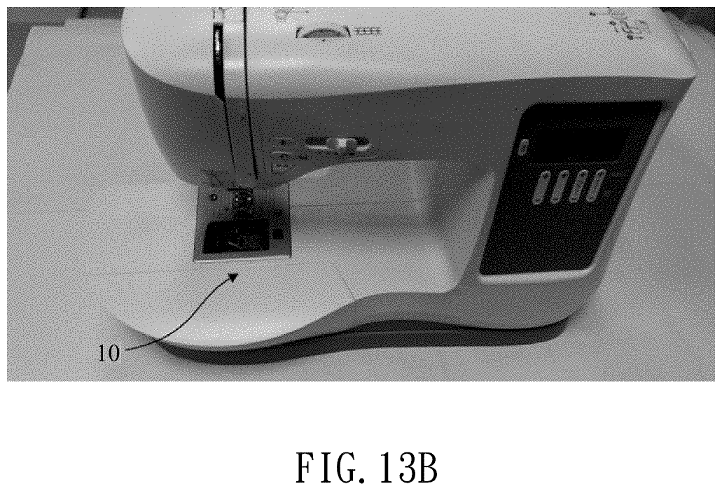

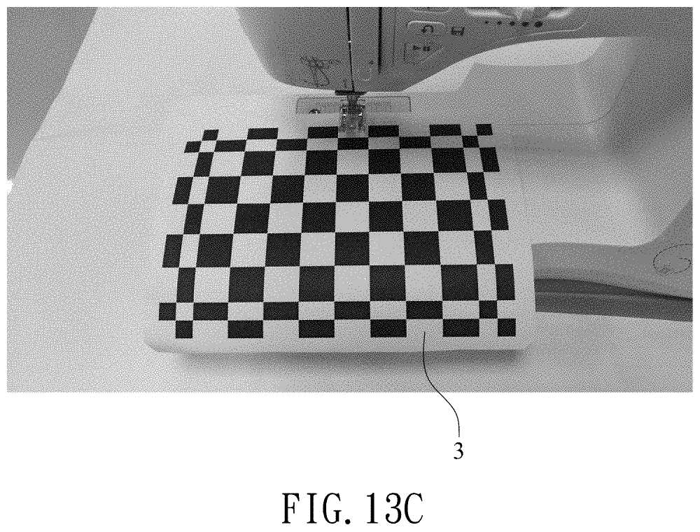

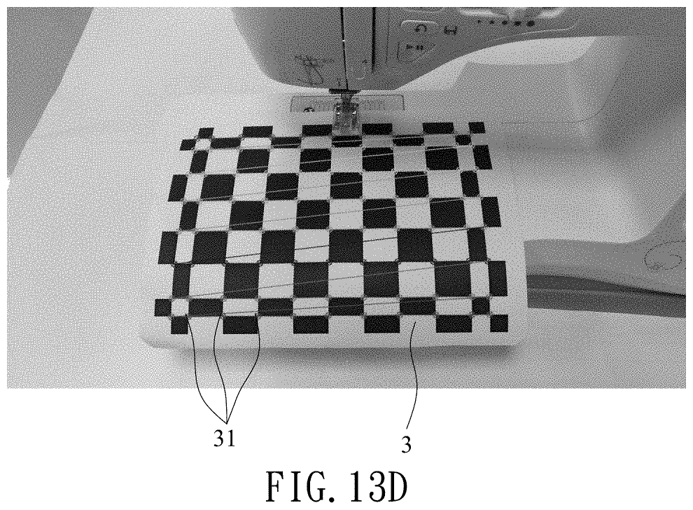

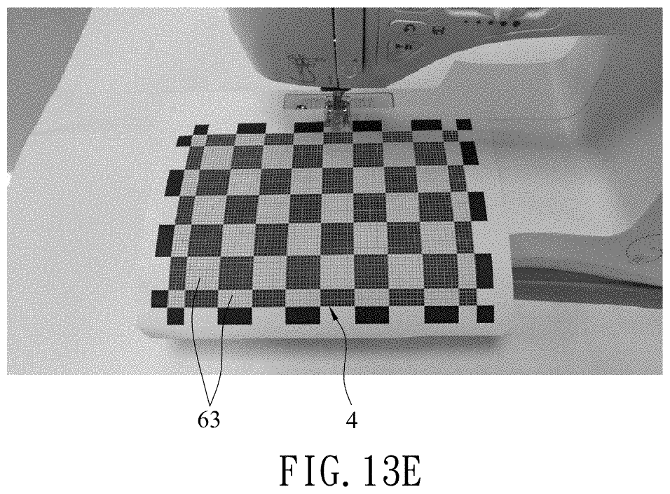

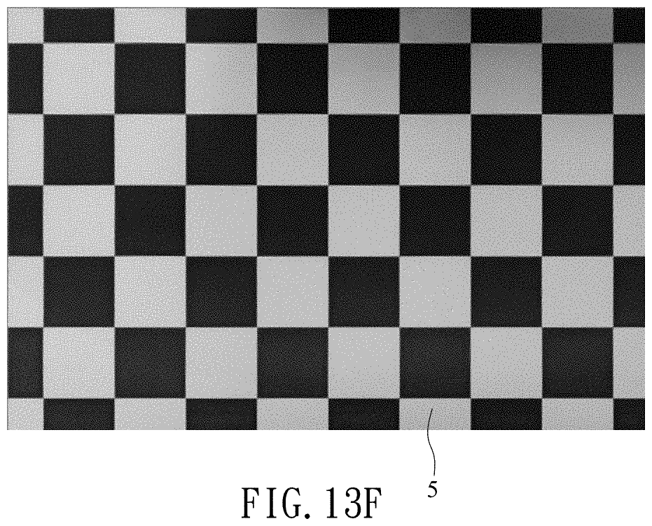

FIGS. 13A-13F illustrate a second exemplary implementation of the embodiment, where the abovementioned image processing method is applied to a computerized embroidery machine.

As shown in FIG. 13A, a checkerboard 22 (e.g., apiece of paper printed with the checkerboard pattern) used in this implementation includes a plurality of first checkers 221 each being 25 mm×25 mm, a plurality of second checkers 222 each being 25 mm×12.5 mm, and a plurality of third checkers 223 each being 12.5mm×12.5 mm. The computerized embroidery machine includes a working bed 10 that has a convex curved surface facilitating embroidering operation, as shown in FIG. 13B. The flexible checkerboard 22 is fittingly overlaid on the working bed 10 (i.e., the part of the checkerboard 22 that is laid over the working bed 10 is slightly deformed to smoothly fit and contact the convex curved surface of the working bed 10), and a camera with a fisheye lens is used to capture an image 3 of the checkerboard 22 (step 11), which has a pixel number of 1164×544, as shown in FIG. 13C.

In accordance with step 12, the computer device acquires a number (11×8) of corner points 31 by corner detection, as shown in FIG. 13D, where each of the corner points 31 is represented as a floating point.

In accordance with step 13, the computer device uses the corner points 31 as interpolation points to calculate a parametric NURBS surface 4 that fits the corner points 31, as shown in FIG. 13E, and calculates a plurality of curved surface points 63 that respectively correspond to the central points of the boxes 64 (see FIG. 6). In this exemplary implementation, both of the degree (p) in the u-axis direction and the degree (q) in the v-axis direction are two, the knot vectors that define the u-axis direction for N_{i,p}(u) are [−2/9, −1/9, 0, 1/9, 2/9, 3/9, 4/9, 5/9, 6/9, 7/9, 8/9, 1, 1+1/9, 1+2/9], the interpolated values in the u-axis direction are [0, 1/18, 3/18, 5/18, 7/18, 9/18, 11/18, 13/18, 15/18, 17/18, 1], the knot vectors that define the v-axis direction for N_{j,q}(v) are [−2/6, −1/6, 0, 1/6, 2/6, 3/6, 4/6, 5/6, 1, 1+1/6, 1+2/6], the interpolated values in the v-axis direction are [0, 1/12, 3/12, 5/12, 7/12, 9/12, 11/12, 1], and each of the weighted values {w_{i,j}} is set to be 1.

In accordance with step 14, the computer device performs, for each curved surface point 63, interpolation based on at least one pixel of a to-be-corrected image (the image 3 shown in FIG. 13C is used as an example of the to-be-corrected image herein) that is adjacent to a position of the curved surface point 63 to acquire a pixel value of a corresponding pixel of a corresponding corrected image. The to-be-corrected image in this example may be any image of an object placed on the working bed 10 which is captured using the fisheye lens.

Note that the curved surface points may be used to perform correction on any image of an object placed on the working bed 10 which is captured using the fisheye lens. FIG. 13F shows a corrected image 5 of the checkerboard 22 that is obtained by performing the abovementioned image correction on a part of the image (see FIG. 13C) that corresponds to the parametric NURBS surface 4 (see FIG. 13E), where the corrected image 5 includes a number 900×600 of pixels.

When the fisheye lens is used to capture an image for recording or previewing an embroidery path of an object (e.g., a fabric piece) placed on the working bed 10, the proposed image processing method may be used to effectively correct the deformation of the object in the real world as captured by the image, and/or the distortion of the object and/or the embroidery path in the image.

In summary, the embodiment of the image processing method according to this disclosure is proposed to capture multiple feature points of an image of a calibration board, calculate a parametric NURBS surface, and perform correction on a to-be-corrected image of any object using the parametric NURBS surface calculated based on the image of the calibration board. Such processing method may be effective on images that have distortion resulting from geometric designs of the camera lenses, lens deformation during manufacturing, imprecision of lens assembly, imprecision of placement of the image sensor, and/or deformation of the captured object itself in the physical/real world.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An image processing method comprising:
acquiring an image of a calibration board;
acquiring a plurality of feature points in the image of the calibration board;
evaluating a plurality of control parameters based on the feature points, the control parameters cooperatively defining a geometric curved surface that fits the feature points; and
performing image correction on a to-be-corrected image based on the geometric curved surface to generate a corrected image.

2. The image processing method of claim 1, wherein the geometric curved surface is a parametric non-uniform rational B-splines surface, and the control parameters respectively correspond to a plurality of control points of the parametric non-uniform rational B-splines surface.

3. The image processing method of claim 2, wherein the generating the corrected image includes:
defining, for the corrected image that has a first image axis and a second image axis transverse to the first image axis, a first pixel number along the first image axis, and a second pixel number along the second image axis, the corrected image having a plurality of pixels of which a number relates to the first pixel number and the second pixel number;
defining, in a domain of the geometric curved surface, the first pixel number of first sample points on a first domain axis, and the second pixel number of second sample points on a second domain axis that is transverse to the first domain axis, the first sample points and the second sample points cooperatively defining, on the geometric curved surface, a plurality of curved surface points each corresponding to a respective one of the pixels of the corrected image; and
generating the corrected image based on the curved surface points and the to-be-corrected image.

4. The image processing method of claim 3, wherein the to-be-corrected image includes a plurality of image pixels, the generating the corrected image further includes:
calculating, for each of the pixels of the corrected image, a pixel value based on at least one of the image pixels of the to-be-corrected image that is adjacent to a position corresponding to one of the curved surface points which corresponds to the pixel of the corrected image.

5. The image processing method of claim 4, wherein, for each of the pixels of the corrected image, the pixel value thereof is calculated by performing interpolation based on said at least one of the image pixels of the to-be-corrected image.

6. The image processing method of claim 4, wherein, for each of the pixels of the corrected image, the pixel value thereof is calculated by calculating a weighted mean based on said at least one of the image pixels of the to-be-corrected image.

7. The image processing method of claim 3, wherein any adjacent two of the first sample points has a same distance therebetween on the first domain axis, and any adjacent two of the second sample points has a same distance therebetween on the second domain axis.

8. The image processing method of claim 1, wherein the calibration board is a checkerboard containing a plurality of corner points, and the acquiring the feature points includes recognizing the corner points to serve as the feature points.

9. The image processing method of claim 1, wherein the calibration board is a dotted board containing a plurality of dots that are spaced apart from each other, and the acquiring the feature points includes recognizing a center of each of the dots to serve as a respective one of the feature points.
